(19) United States
(12) Patent Application Publication
(10) Pub. No.: US 2026/0256064 A1
(43) Pub. Date: Sep. 3, 2026

(54) BLOWER

(71) Applicant: Nanjing Chervon Industry Co., Ltd., Nanjing (CN)

(72) Inventors: Toshinari Yamaoka, Nanjing (CN); Jianpeng Guo, Nanjing (CN); Lele Liu, Nanjing (CN); Slobodan Zivanovic, Nanjing (CN)

(21) Appl. No.: 19/652,361

(22) Filed: Apr. 20, 2026

Related U.S. Application Data
(63) Continuation-in-part of application No. 18/457,110, filed on Aug. 28, 2023.
Application No. 18/457,110 is a continuation of application No. PCT/CN2022/079932, filed on Mar. 9, 2022.

(30) Foreign Application Priority Data
Apr. 19, 2021 (CN) 202110417507.7
Dec. 24, 2025 (CN) 202511965461.7
Dec. 24, 2025 (CN) 202522743439.X

(51) Int. Cl. A01G 20/47; A47L 5/14; A47L 9/28; A47L 9/32; E01H 1/08; F04D 25/06

(52) U.S. Cl. CPC A01G 20/47; A47L 5/14; A47L 9/2884; A47L 9/322; E01H 1/0809; F04D 25/0673

(57) ABSTRACT

A blower includes: a motor; a fan driven by the motor to rotate about a central axis; a battery pack for supplying power to the motor; and a blower tube assembly forming an air inlet for the entry of air and an air outlet for the exit of the air. The blower further includes: a first handle forming a first grip for a hold and a second handle forming a second grip for a hold, where at least part of a projection of the battery pack along a radial direction of the central axis on a plane passing through the central axis is located between the first handle and the second handle.

### RELATED APPLICATION INFORMATION

This application is a continuation-in-part of U.S. patent application Ser. No. 18/457,110, filed on Aug. 28, 2023, which application is a continuation of International Application No. PCT/CN2022/079932, filed on Mar. 9, 2022, which application claims the benefit of Chinese Patent Application No. CN 202110417507.7, filed on Apr. 19, 2021.

This application also claims the benefit under 35 U.S.C. § 119(a) of Chinese Patent Application No. 202511965461.7, filed on Dec. 24, 2025, and Chinese Patent Application No. 202522743439.X, filed on Dec. 24, 2025.

Each of these references to which priority is claimed in incorporated herein by reference in its entirey.

### TECHNICAL FIELD

The present application relates to a power tool and, in particular, to a blower.

### BACKGROUND

A blower is a commonly used garden tool, which can help a user clean fallen leaves in a garden with an airflow. When the blower ejects gas, the ejected object generates a recoil force in a reverse direction due to conservation of momentum. As a result, when holding the blower, the user needs to suppress the recoil force generated by the blower to prevent the blower from deflecting. Consequently, the fatigue of the user is increased, which is not conducive to performing an operation for a long time. In addition, in order that the performance of the blower is improved, the weight of a battery pack and the weight of the blower are both increased accordingly, which is not conducive to performing the operation for a long time by the user. As a result, the improvement of the performance of the blower is further limited.

### SUMMARY

The present application provides a blower. The blower includes: a motor; a fan driven by the motor to rotate about a central axis; a battery pack for supplying power to the motor; and a blower tube assembly forming an air inlet for the entry of air and an air outlet for the exit of the air. The blower further includes a first handle forming a first grip for a hold and a second handle forming a second grip for a hold, where a first plane passing through the central axis exists, where at least part of the blower tube assembly is distributed symmetrically with respect to the first plane, and a projection of the battery pack on the first plane is at least partially located between a projection of the first handle on the first plane and a projection of the second handle on the first plane.

In some examples, the first handle and the second handle are each located on a side of the blower tube assembly and relatively independent of each other.

In some examples, the battery pack, the first handle, and the second handle are located on the same side of the blower tube assembly, and the battery pack is located between the first handle and the second handle.

In some examples, the battery pack, the first handle, and the second handle are located on the blower tube assembly.

In some examples, the first handle and the second handle are located on the blower tube assembly, and the battery pack is located under the blower tube assembly.

In some examples, the first handle is located behind the blower tube assembly, one of the second handle and the battery pack is located on the blower tube assembly, and the other one of the second handle and the battery pack is located under the blower tube assembly.

In some examples, the central axis passes through at least part of the first grip.

In some examples, the first handle or the second handle is disposed around the blower tube assembly.

In some examples, the battery pack is at least partially located behind the air inlet.

In some examples, when an airflow flows into the blower tube assembly through the air inlet, the battery pack is at least partially located on an extension line of an air path of the inflow airflow.

In some examples, the weight of the battery pack is greater than or equal to 3 kg and less than or equal to 6 kg.

In some examples, the rated power of the motor is greater than or equal to 1200 W and less than or equal to 4000 W, and the air volume of the air outlet of the blower is greater than or equal to 700 cubic feet per minute.

In some examples, the present application provides a blower. The blower includes: a motor; a fan driven by the motor to rotate about a central axis; a battery pack for supplying power to the motor; and a blower tube assembly forming an air inlet for the entry of air and an air outlet for the exit of the air. The blower further includes a first handle forming a first grip for a hold and a second handle forming a second grip for a hold. The rated power of the motor is greater than or equal to 1200 W and less than or equal to 4000 W, and the air volume of the air outlet of the blower is greater than or equal to 700 cubic feet per minute.

In some examples, the battery pack is detachably connected to the blower, and the overall weight of the blower with no battery pack mounted is greater than or equal to 1.8 kg and less than or equal to 3 kg.

In some examples, the diameter of the fan is larger than or equal to 85 mm and smaller than or equal to 100 mm.

In some examples, the present application provides a blower. The blower includes: a motor; a fan driven by the motor to rotate about a central axis; a battery pack coupling portion for connecting a battery pack for supplying power to the motor; and a blower tube assembly forming an air inlet for the entry of air and an air outlet for the exit of the air. The blower further includes a first handle forming a first grip for a hold and a second handle forming a second grip for a hold, where a first plane passing through the central axis is defined, where at least part of the blower tube assembly is distributed symmetrically with respect to the first plane, at least part of an orthographic projection of the battery pack coupling portion on the first plane is located between a projection of the first handle on the first plane and a projection of the second handle on the first plane.

Benefits are described below. In the present application, a double-handle structure is provided and the position of the battery pack is configured so that the distance between the position where the blower is held by a user and a recoil force generated when the blower runs is reduced. In addition, it is convenient for the user to operate the blower with the double-handle structure so that the weight and capacity of the battery pack can be increased accordingly, thereby increasing the volume of air exiting from the blower and reducing the burden on the user. Specifically, the moment of force generated at the hold position by the recoil force generated when the blower runs is reduced so that the burden on the user during the use of the blower is reduced.

### BRIEF DESCRIPTION OF THE DRAWINGS

FIG. 1 is a perspective view of a blower according to a first example of the present application;

FIG. 2 is a plan view of the blower in FIG. 1;

FIG. 3 is a sectional view of the blower in FIG. 1;

FIG. 4 is a perspective view of a blower according to a second example of the present application;

FIG. 5 is a plan view of the blower in FIG. 4;

FIG. 6 is a plan view of a blower according to a third example of the present application;

FIG. 7 is a plan view of a blower according to a fourth example of the present application;

FIG. 8 is a plan view of a blower according to a fifth example of the present application;

FIG. 9 is a perspective view of a blower according to a sixth example of the present application;

FIG. 10 is a schematic view of the blower in FIG. 9 from another angle;

FIG. 11 is a side view of the blower in FIG. 9;

FIG. 12 is a top view of the blower in FIG. 9;

FIG. 13 is a schematic view of an example of the present application;

FIG. 14 is a schematic view of an example of the present application from another angle;

FIG. 15 is a front view of an example of the present application;

FIG. 16 is a top view of an example of the present application;

FIG. 17 is a schematic view of an example of the present application, with an extension tube removed;

FIG. 18 is a schematic view of an example of the present application from another angle, with an extension tube removed;

FIG. 19 is a front view of an example of the present application, with an extension tube removed;

FIG. 20 is a front view of an example of the present application, with a battery pack removed;

FIG. 21 is a schematic view of an example of the present application, with a handle portion in a tilted state;

FIG. 22 is a front view of an example of the present application, with a handle portion in a tilted state;

FIG. 23 is a schematic view of an example of the present application provided with another second handle;

FIG. 24 is a front view of an example of the present application provided with another second handle;

FIG. 25 is a schematic view of an example of the present application provided with a second handle rotatable;

FIG. 26 is a front view of an example of the present application provided with a second handle rotatable;

FIG. 27 is a schematic view of an example of the present application provided with another second handle rotatable; and

FIG. 28 is a front view of an example of the present application provided with another second handle rotatable.

### DETAILED DESCRIPTION

Examples of the present application are described below in detail with reference to the drawings. The same or similar reference numerals indicate the same or similar elements or elements having the same or similar functions. The examples described below with reference to the drawings are only intended to explain the present application and are not to be construed as limiting the present application.

In the description of the present application, the terms “joined”, “connected”, and “fixed” are to be understood in a broad sense unless otherwise expressly specified and limited. For example, the term “connected” may refer to “fixedly connected”, “detachably connected”, or integrated, may refer to “mechanically connected” or “electrically connected”, or may refer to “connected directly”, “connected indirectly through an intermediary”, “connected inside two elements”, or “interaction relations between two elements”. For those of ordinary skill in the art, specific meanings of the preceding terms in the present application may be understood based on specific situations.

The present application is described below in detail in conjunction with the drawings and the examples.

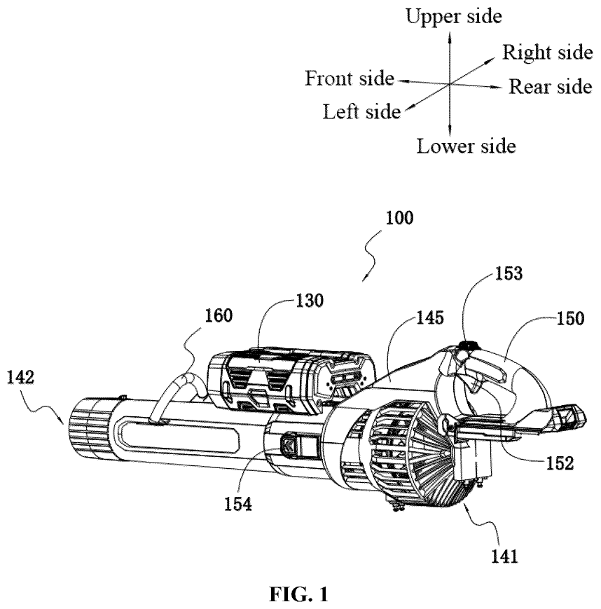

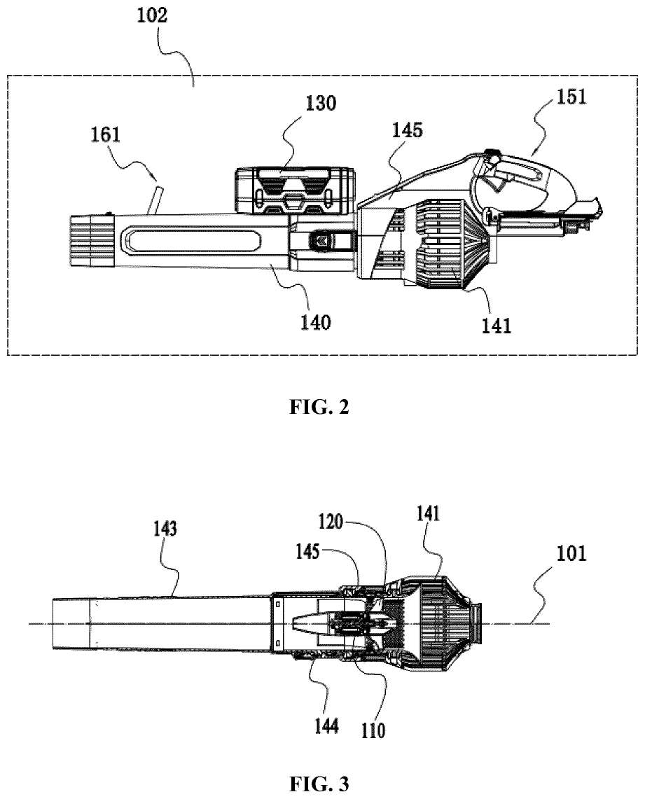

Referring to FIGS. 1 to 3, in an example of the present application, a blower 100 includes a motor 110, a fan 120, a battery pack 130, a blower tube assembly 140, and a first handle 150. The blower tube assembly 140 forms an air inlet 141 for the entry of air and an air outlet 142 for the exit of the air. The fan 120 is driven by the motor 110 to rotate about a central axis 101, and the battery pack 130 is used for supplying power to the motor 110. The fan 120 rotates to guide an airflow to enter the inside of the blower tube assembly 140 from the air inlet 141 and exit from the air outlet 142. The airflow is used for assisting in cleaning fallen leaves or other debris. The blower 100 further includes a switch 152 for controlling the start and stop of the machine, an air speed adjustment button 153 for adjusting the speed at which the air exits, and a maximum air speed key 154 for maintaining the blower 100 at the maximum air speed. In a first example, the switch 152 is disposed at the first handle 150. When the switch 152 is pulled, the blower 100 starts working. When the switch 152 is released, the blower 100 stops working. Specifically, the switch 152 is a trigger. Before the switch 152 is turned on, the air speed adjustment button 153 needs to be adjusted to a required speed at which the air exits, and then the switch 152 is turned on for performing a blowing operation. When a local area with a relatively enormous operation difficulty is encountered during the blowing operation, the speed at which the air exits may be temporarily adjusted to the maximum air speed through the maximum air speed key 154. When the maximum air speed does not need to be used, the state of the maximum air speed key 154 is changed so that a current air speed of the blower 100 returns to a speed specified by the air speed adjustment button 153. In some examples, the switch 152 is disposed at another position of the blower 100 instead of the handle.

The blower 100 further includes the first handle 150 forming a first grip 151 for a hold and a second handle 160 forming a second grip 161 for a hold. The first handle 150 is disposed behind the second handle 160, and the first handle 150 and the second handle 160 are configured to be relatively independent of each other. When operating the blower 100, the user may hold the first grip 151 of the first handle 150 and the second grip 161 of the second handle 160 with two hands separately so that the blower 100 can be operated more stably. Specifically, the first handle 150 is located substantially on the air inlet 141 and behind the air inlet 141, and the second handle 160 is located at a position which is on the blower tube assembly 140 and near the air outlet.

When the user holds the first handle 150 and the second handle 160 and uses the blower for performing a blow, the airflow is ejected outward through the air outlet 142 substantially along a first direction parallel to the central axis 101. In this case, the user is subjected to a recoil force generated by the ejection of the airflow, where the recoil force is substantially in a second direction opposite to the first direction. The recoil force generates the moment of force on the grip. To prevent the moment of force from driving the position of the whole blower 100 to be deflected, the user needs to give a force to overcome the moment of force in addition to bearing the gravity of the blower 100. There is a certain distance between the first handle 150 and the second handle 160, and the second handle 160 is provided so that the user can more easily overcome the moment of force generated by the recoil force, thereby making better use of the blower 100.

The switch 152 for controlling the motor 110 is disposed on the first handle 150. The user holds the first handle 150 and can press the switch 152 to control the running of the motor 110 when holding the first handle 150. The blower tube assembly 140 includes a first blower tube 143 and a second blower tube 144. The first blower tube 143 and the second blower tube 144 partially overlap each other. Specifically, part of the second blower tube 144 is disposed in the first blower tube 143, and the air outlet 142 is disposed at an end of the first blower tube 143. The blower 100 further includes a connection portion 145 and a hood, where the connection portion 145 connects the second blower tube 144 to the first handle 150, the connection portion 145 is configured to be open so that the air inlet 141 is formed, and the hood covers the outside of the air inlet 141. A flow guide cone for fixing the motor 110 is formed in the second blower tube 144, where the motor 110 is disposed in the flow guide cone, and the fan 120 is disposed behind the flow guide cone. The motor 110 includes a rotatable shaft of the motor 110, where the shaft of the motor 110 extends out from the inside of the flow guide cone and is connected to the fan 120, and the fan 120 can be driven by the shaft of the motor 110 to rotate about the central axis 101.

In some examples, the switch 152 is disposed on the second handle 160 and the user can control the switch 152 to be turned on or off when holding the second handle 160.

In the first example of the present application, the first handle 150 and the second handle 160 are each located on a side of the blower tube assembly 140 and relatively independent of each other. The first handle 150 and the second handle 160 may be disposed on the blower tube assembly 140. The blower 100 is further provided with a base disposed under the blower 100. Specifically, the base is located under the blower tube assembly 140. The base is disposed opposite to the first handle 150 and the second handle 160 and used for supporting the blower 100 on a plane. When the blower 100 is not required to be used, the blower 100 may be placed on the base so that the blower 100 does not easily tumble, which facilitates safe storage.

The battery pack 130, the first handle 150, and the second handle 160 are located on the same side of the blower tube assembly 140, and the battery pack 130 is located between the first handle 150 and the second handle 160. The battery pack 130 is connected to a battery pack coupling portion of the blower 100.

A first plane 102 passing through the central axis 101 exists, where at least part of the blower tube assembly 140 is distributed symmetrically with respect to the first plane 102, and a projection of the battery pack 130 on the first plane 102 is at least partially located between a projection of the first handle 150 on the first plane and a projection of the second handle 160 on the first plane.

In some examples, the battery pack 130, the first handle 150, and the second handle 160 are located on the blower tube assembly 140. A gap is disposed between the first handle 150 and the second handle 160, and the battery pack 130 is placed into the gap so that at least part of a projection of the battery pack 130 along a radial direction of the central axis 101 is located between the first handle 150 and the second handle 160, thereby making the balance of the blower 100 better. The overall center of gravity of the blower 100 to which the battery pack 130 is mounted is located between the first handle 150 and the second handle 160 or located in a projection of the first handle 150 or a projection of the second handle 160 in the radial direction of the central axis 101, thereby facilitating the hold of the user and improving the user's comfort in using the blower 100. In some examples, the projection of the battery pack 130 along the radial direction of the central axis 101 is located between the first handle 150 and the second handle 160, and the projection of the battery pack 130 in this direction does not overlap the projection of the first handle 150 or the projection of the second handle 160 in this direction.

Double handles are disposed so that the burden on the user during the use of the blower 100 can be reduced. The weight of the battery pack 130 which can be mounted to the blower 100 is increased so that the performance of the battery pack 130 can be improved. In some examples, the weight of the battery pack 130 is set to be greater than or equal to 3 kg and less than or equal to 6 kg. In some examples, the weight of the battery pack 130 is set to be greater than or equal to 3.5 kg and less than or equal to 6 kg. In some examples, the weight of the battery pack 130 is set to be greater than or equal to 4 kg and less than or equal to 6 kg.

Accordingly, the rated power of the motor 110 can be set to be greater than or equal to 1500 W and less than or equal to 4000 W, and the diameter of the fan 120 is larger than or equal to 85 mm and smaller than or equal to 100 mm so that the air volume of the blower 100 at the air outlet 142 can be greater than or equal to 700 cubic feet per minute. Thus, the air volume of the blower 100 is increased and the battery life of the blower 100 can be prolonged. The battery pack 130 is detachably connected to the blower 100, and the overall weight of the blower 100 with no battery pack 130 mounted is greater than or equal to 1.8 kg and less than or equal to 3 kg. In some examples, the blower 100 is provided with no base.

In some examples, the rated power of the motor 110 can be set to be greater than or equal to 1500 W and less than or equal to 4000 W, and the diameter of the fan 120 is larger than or equal to 80 mm and smaller than or equal to 110 mm so that the air volume of the blower 100 at the air outlet 142 can be greater than or equal to 600 cubic feet per minute and less than or equal to 1000 cubic feet per minute. Thus, the air volume of the blower 100 is increased and the battery life of the blower 100 can be prolonged. The battery pack 130 is detachably connected to the blower 100, and the overall weight of the blower 100 with no battery pack 130 mounted is greater than or equal to 1.5 kg and less than or equal to 4 kg.

In some examples, the rated power of the motor 110 can be set to be greater than or equal to 1200 W and less than or equal to 4000 W. In some examples, the rated power of the motor 110 can be set to be greater than or equal to 1300 W and less than or equal to 4000 W. In some examples, the rated power of the motor 110 can be set to be greater than or equal to 1400 W and less than or equal to 4000 W. In some examples, the rated power of the motor 110 can be set to be greater than or equal to 1500 W and less than or equal to 4000 W. In some examples, the rated power of the motor 110 can be set to be greater than or equal to 1600 W and less than or equal to 4000 W.

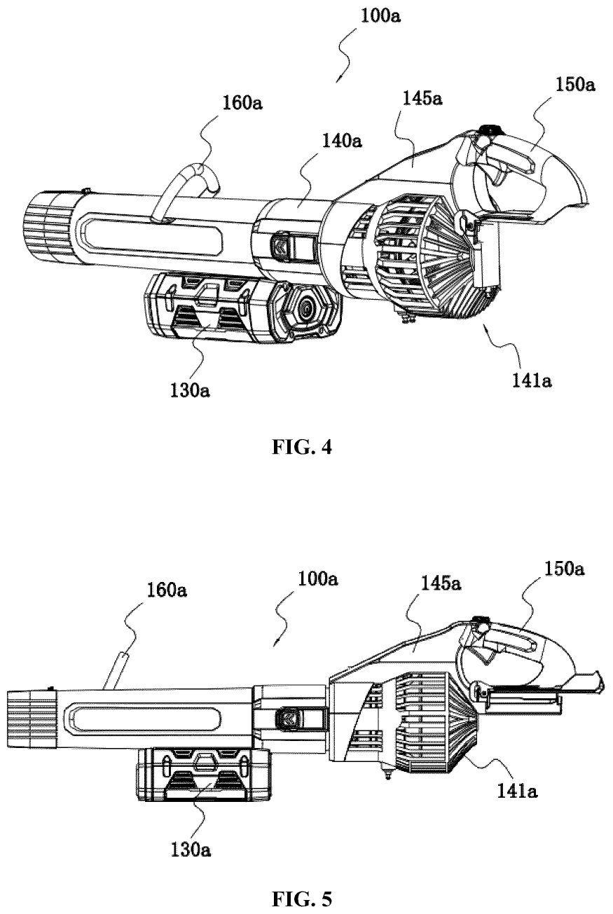

Referring to FIGS. 4 and 5, in a second example of the present application, a first handle 150a and a second handle 160a are located on a blower tube assembly 140a, and a battery pack 130a is located under the blower tube assembly 140a. At least part of a projection of the battery pack 130a along a radial direction of a central axis is located between the first handle 150a and the second handle 160a, thereby making the balance of a blower 100a better. The overall center of gravity of the blower 100a to which the battery pack 130a is mounted is located between the first handle 150a and the second handle 160a or located in a projection of the first handle 150a or a projection of the second handle 160a in the radial direction of the central axis, thereby facilitating the hold of the user and reducing the user's fatigue during the use of the blower 100a. A connection portion 145a connects the blower tube assembly 140a to the first handle 150a, and the lower end of the connection portion 145a is connected to a hood enclosing an air inlet 141a. In some examples, the projection of the battery pack 130a along the radial direction of the central axis is located between the first handle 150a and the second handle 160a, and the projection of the battery pack 130a in this direction does not overlap the projection of the first handle 150a or the projection of the second handle 160a in this direction. The blower further includes a base for supporting the blower so that the blower can stand on a plane. In some examples, the battery pack is connected to the base. In some examples, the blower is provided with no base.

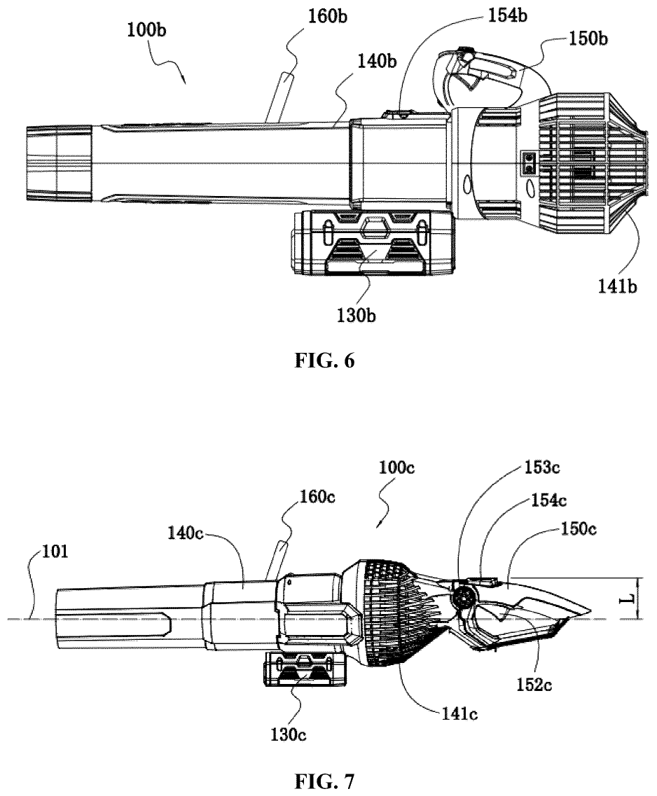

Referring to FIG. 6, in a third example of the present application, a first handle 150b, a second handle 160b, and a battery pack 130b of a blower 100b are each in front of an air inlet 141b, and the first handle 150b, the second handle 160b, and the battery pack 130b are each connected to a blower tube assembly 140b. In this example, the first handle 150b is directly connected to the blower tube assembly 140b, and a maximum air speed key is located on the blower tube assembly 140b. Specifically, a maximum air speed key 154b is located above the battery pack 130b to facilitate the operation of an operator.

Referring to FIG. 7, in a fourth example of the present application, a first handle 150c of a blower 100c is located behind a blower tube assembly 140c, and a second handle 160c of the blower 100c is located on the blower tube assembly 140c. In some examples, a battery pack 130c is located between the first handle and the second handle and located on the blower tube assembly 140c. At least part of a projection of the battery pack 130c along a radial direction of a central axis is located between the first handle 150c and the second handle 160c, thereby making the balance of the blower 100c better. In some examples, the battery pack 130c is located between the first handle and the second handle, in front of an air inlet 141c, and under the blower tube assembly 140c. A maximum air speed key 154c is adjusted to the top of the first handle 150c in the form of a button, and an air speed adjustment button 153c is adjusted to a side surface of the first handle 150c. Thus, it is convenient for an operator to press the maximum air speed key 154c with a thumb while pressing a switch 152c. This operation is easy and convenient. The maximum air speed key 154c is adjusted to a position above the switch 152c, and similarly, this position may be conveniently touched by a finger of a hand for a hold when the blower 100c is held.

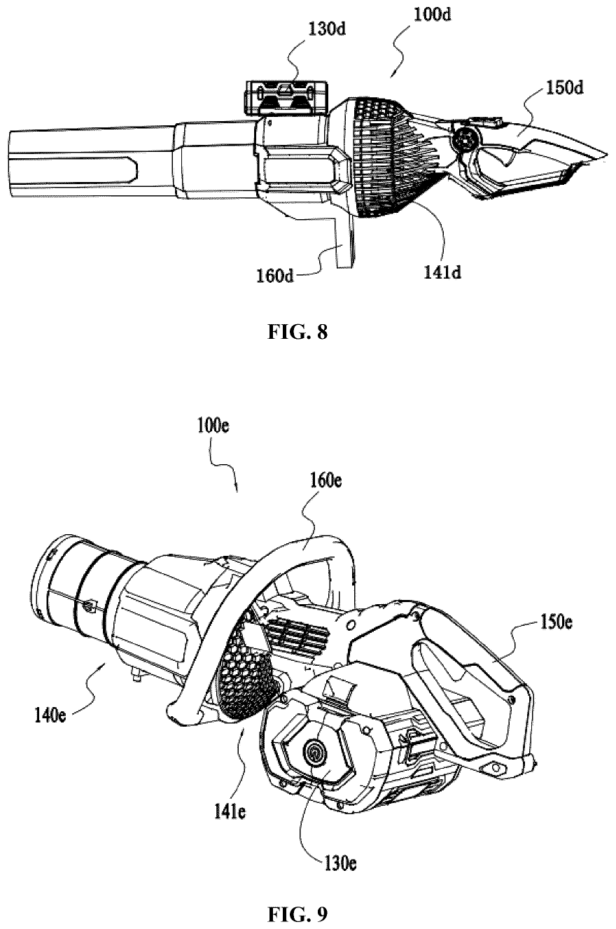

Referring to FIG. 8, in a fifth example of the present application, a first handle 150d of a blower 100d is located behind a blower tube assembly, and a second handle 160d of the blower 100d is located under the blower tube assembly. Specifically, the second handle 160d is located at a position under the blower tube assembly and near a hood of an air inlet 141d.

The first handle 150c in FIG. 7 and the first handle 150d in FIG. 8 are based on the same design concept. As shown in FIG. 7, the vertical distance between the highest point of the first grip 151 and the central axis 101 is a first distance L. In the fourth and fifth examples, the first distance L is less than or equal to 140 mm.

In the related art, the first handle 150 of the blower 100 is mostly similar to the first handles in FIGS. 1, 4, and 6, that is, the highest point of the first handle 150 is significantly higher than the highest point of the blower tube assembly 140. However, for a blower 100 with power of greater than 1200 W, a blower 100 with power of greater than 1600 W, or a blower 100 with power of greater than 2000 W in some examples, if the position of the first handle 150 is lowered so that the first grip 151 is as near to the central axis 101 as possible, the counteraction of huge torsion generated when the blower 100 with relatively high power works is facilitated and the user experience of the operator is optimized. Thus, the central axis 101 passes through at least part of the first grip.

In some examples, the first handle or the second handle is disposed around the blower tube assembly.

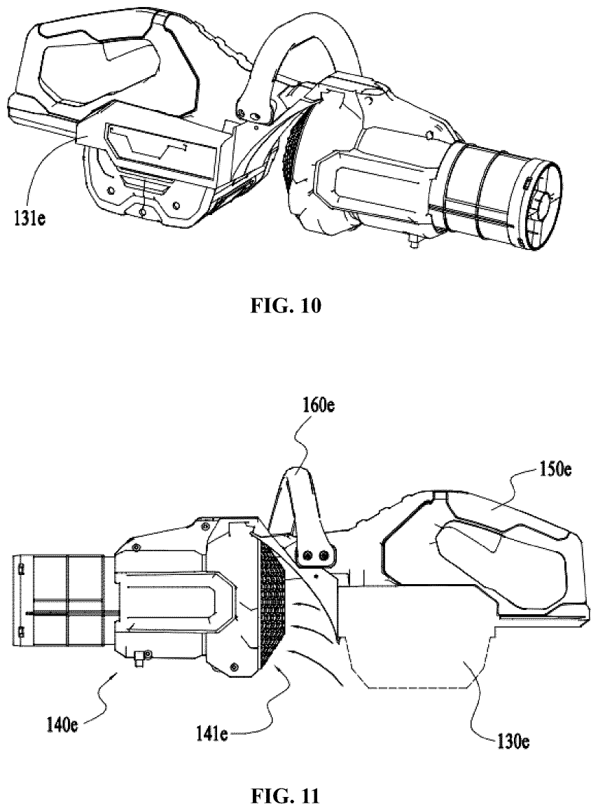

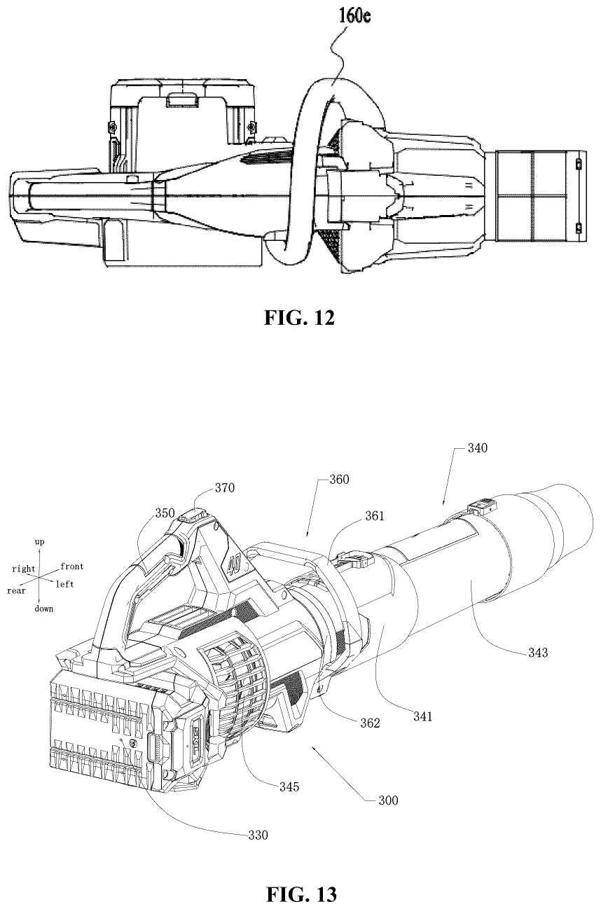

Referring to FIGS. 9 to 12, in a sixth example of the present application, a second handle 160e of a blower 100e is disposed around a blower tube assembly 140e. Specifically, the second handle 160e has a spiral shape and is disposed around the blower tube assembly 140e. Further, according to directional legends in FIG. 1, the operator may hold the second handle 160e from the upper side, the left side, the right side, and the like of the second handle 160e. This example provides various hold angles so that the operation is more flexible and convenient.

The first handle 150e is located behind the second handle 160e and the blower tube assembly 140e. The first handle 150e in this example is nearer to the central axis 101 than the first handles in the first, second and third examples. An air inlet 141e is located substantially below the second handle 160e, and a battery pack 130e is located substantially under the first handle 150e and at least partially located behind the air inlet 141e. The battery pack 130e and the first handle 150e are configured in this manner so that the center of gravity of the blower 100e is near the central axis 101, thereby improving the comfort of the hold. As shown in FIG. 11, an approximate track of an air duct through which the airflow flows is shown behind the air inlet 141e, and when the airflow flows into the blower tube assembly 140e through the air inlet 141e, the battery pack 130e is at least partially located on an extension line of an air path of the inflow airflow.

The blower 100e includes a battery pack coupling portion 131e for connecting the battery pack 130e for supplying power to the motor 110. During an actual design, the battery pack 130e may be designed to be inserted from a side of the first handle 150e. For example, the battery pack 130e may be inserted from left to right into the battery pack coupling portion 131e accommodating the battery pack 130e, inserted from right to left into the battery pack coupling portion 131e accommodating the battery pack 130e, or inserted from a lower side to an upper side into the battery pack coupling portion 131e accommodating the battery pack 130e. It is to be understood that for each of the preceding examples, the battery pack coupling portion may be disposed in an open environment, a semi-open environment, or a completely closed environment, which does not affect the technical effect of the present application and falls within the scope of the present application.

To sum up, in the first to sixth examples disclosed in FIGS. 1 to 12, the at least part of the projection of the battery pack along the radial direction of the central axis 101 on the plane passing through the central axis 101 is located between the first handle 150 and the second handle 160. This plane passing through the central axis 101 may be a plane which is along an up and down direction and passes through the central axis 101. In this case, the at least part of the projection of the battery pack along the radial direction of the central axis 101 on this plane is located between the first handle 150 and the second handle 160.

In the present application, unless otherwise expressly specified and limited, when a first feature is described as “on” or “under” a second feature, the first feature and the second feature may be in direct contact or be in contact via another feature between the two features instead of being in direct contact. Moreover, when the first feature is described as “on”, “above”, or “over” the second feature, the first feature is right on, above, or over the second feature or the first feature is obliquely on, above, or over the second feature, or the first feature is simply at a higher level than the second feature. When the first feature is described as “under”, “below”, or “underneath” the second feature, the first feature is right under, below, or underneath the second feature or the first feature is obliquely under, below, or underneath the second feature, or the first feature is simply at a lower level than the second feature.

During operation of the blower, a rechargeable battery pack is used as a power supply. In this example, the battery pack is a battery set, and the battery pack collaborates with a corresponding power circuit to supply power to the blower. It is to be understood by those skilled in the art that in other examples, the blower may be powered through other power supply devices. For example, the power supply may be an alternating current wire connected to mains electricity, or the power supply may be another connection cable connectable to a power supply device. The corresponding components in the blower are powered by mains electricity or another power supply device in collaboration with corresponding rectifier, filter, and voltage regulator circuits. The battery pack is used below instead of the power supply, which is not to limit the present application.

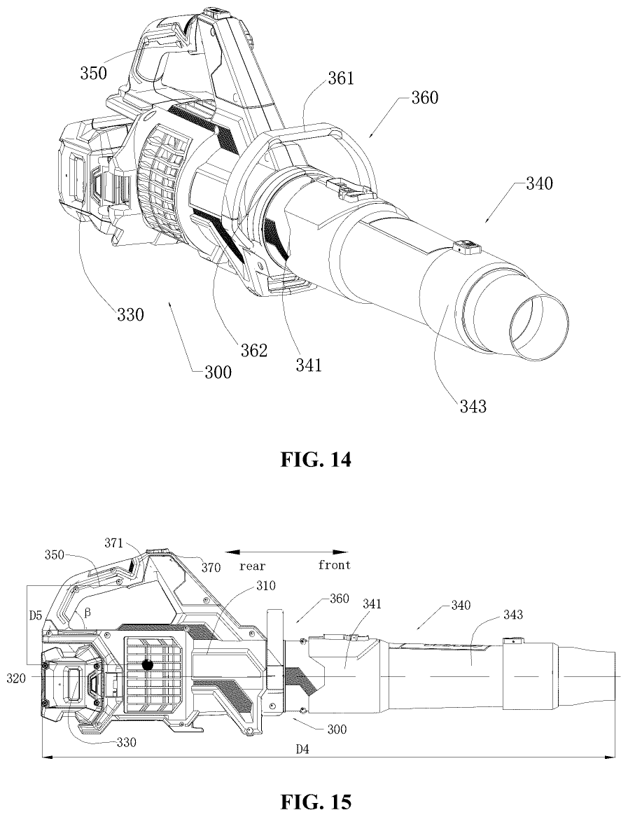

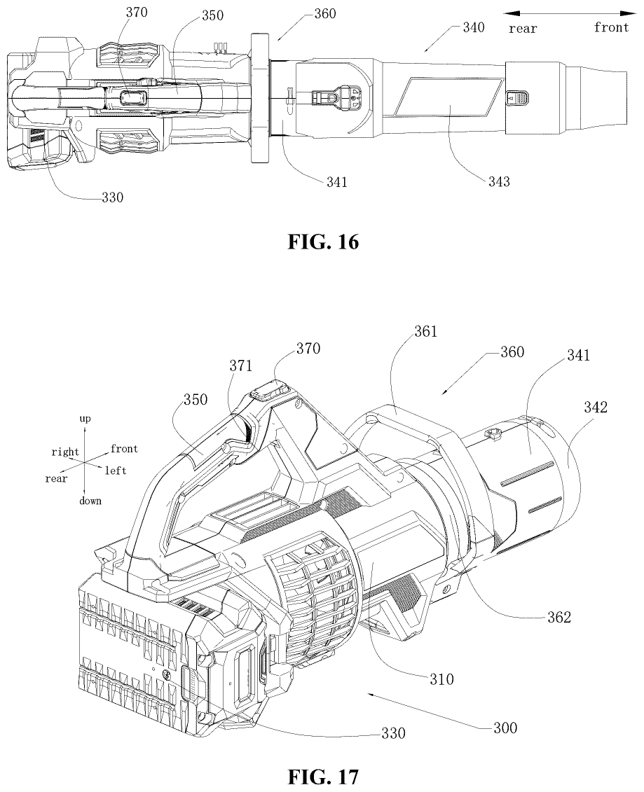

Existing blowers on the market have a relatively large axial dimension from an air inlet to an air outlet, resulting in inconvenient operations and a relatively high labor intensity of users. To solve the preceding problems, as shown in FIGS. 13 to 28, the present application provides a blower 300. The blower 300 includes a motor, a fan, a battery pack receptacle 331, a blower tube assembly 340, a first handle 350, and a second handle 360.

The fan is driven by the motor to rotate about a central axis 320. The battery pack receptacle 331 is used for connecting a battery pack 330 to supply power to the motor. The blower tube assembly 340 is formed with an air inlet 345 for air intake and an air outlet 344 for air discharge, and the fan is accommodated in the blower tube assembly 340. The first handle 350 is used for a user to hold with one hand. The second handle 360 is disposed in front of the first handle 350 and used for the user to hold with the other hand. The first handle 350 is disposed above the battery pack 330, and the top of the first handle 350 is higher than the top of the second handle 360. During operation of the blower 300, the battery pack 330 supplies power to the motor, and the motor drives the fan to rotate so that negative pressure is formed at the air inlet 345, and external air is drawn in, passes through the fan, and is blown out from the air outlet 344 to clean the environment.

Through the above arrangement, the user can hold the first handle 350 and the second handle 360 with both hands along a front and rear direction, facilitating the handheld use. Moreover, handle addition enables the holding of the user with both hands and thus reduces the labor intensity during single-hand use. The top of the first handle 350 is higher than the top of the second handle 360, which better conforms to ergonomics and is convenient for the user to flexibly adjust the posture of the blower 300 according to usage occasions. Moreover, the user can use the first handle 350 or the second handle 360 alone according to actual requirements, improving flexibility of use and user experience.

In some examples, the first handle 350 is disposed above the blower tube assembly 340. The first handle 350 is disposed above the blower tube assembly 340, making it convenient for the user to lift the blower 300 by hand and facilitating the use by the user.

As shown in FIGS. 13 to 15, in some examples, the first handle 350 extends along a direction of the central axis 320 and includes multiple tubular portions connected in sequence, and a rearmost tubular portion is holdable. Through the above arrangement, the first handle 350 and the central axis 320 extend in the same direction so that when the user holds the first handle 350 by hand, a force on the wrist is reduced, thereby reducing the labor intensity. Moreover, the first handle 350 has a certain length and thus is formed with multiple grip positions, making it convenient for the user to hold different positions as required and facilitating the use. The rearmost tubular portion is also designed to be a holdable position, facilitating the holding of the user. The first handle 350 is designed to be tubular, and the tubular structure has good mechanical properties of bending and torsion resistance, ensuring sufficient strength. Additionally, the first handle 350 is a hollow structure light in weight, thereby reducing the overall weight of the blower 300, reducing the labor intensity of the user during handheld use, saving a material, and achieving a lightweight design.

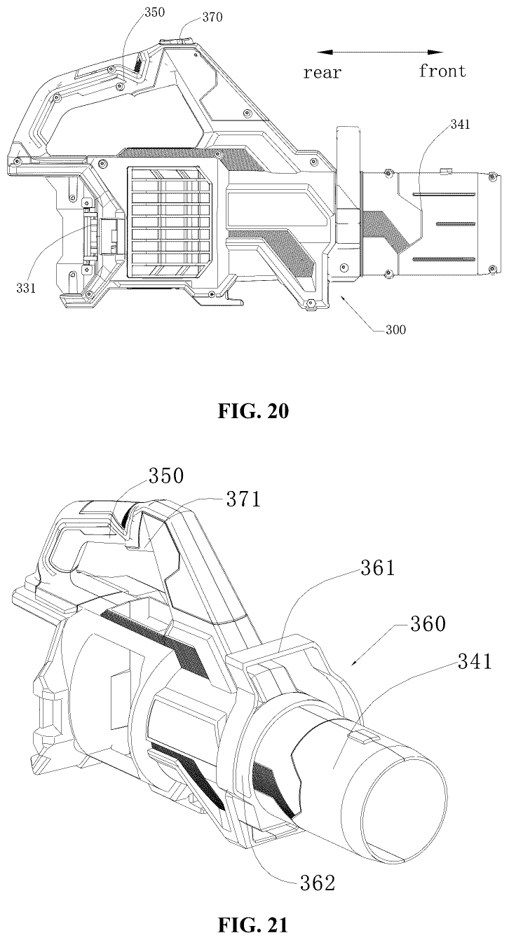

As shown in FIGS. 19 and 20, in some examples, the battery pack receptacle 331 is disposed behind the air inlet 345. Since the battery pack receptacle 331 is used for connecting the battery pack 330 and the battery pack 330 is relatively heavy, the arrangement of the battery pack receptacle 331 behind the air inlet 345 is beneficial for balancing the overall center of gravity of the blower 300. Since the first handle 350 is located above the battery pack 330, during the use by the user, the moment of force from the wrist to the overall center of gravity of the blower can be reduced, thereby reducing the force on the wrist. Moreover, the battery pack receptacle 331 can be designed to be open and is not affected by other components of the blower 300, making it convenient to arrange, as required, battery packs 330 with different volumes.

As shown in FIG. 20, in some examples, the battery pack 330 is mountable to the battery pack receptacle 331 by sliding in a left and right direction. The battery pack 330 is designed to be detachable so that during use of the blower 300, the battery pack 330 out of power can be simply detached and replaced with a new battery pack 330. The battery pack 330 is mounted by sliding in the left and right direction, facilitating the mounting of the battery pack 330 and ensuring the effective mating with the battery pack receptacle 331 to achieve an electrical connection.

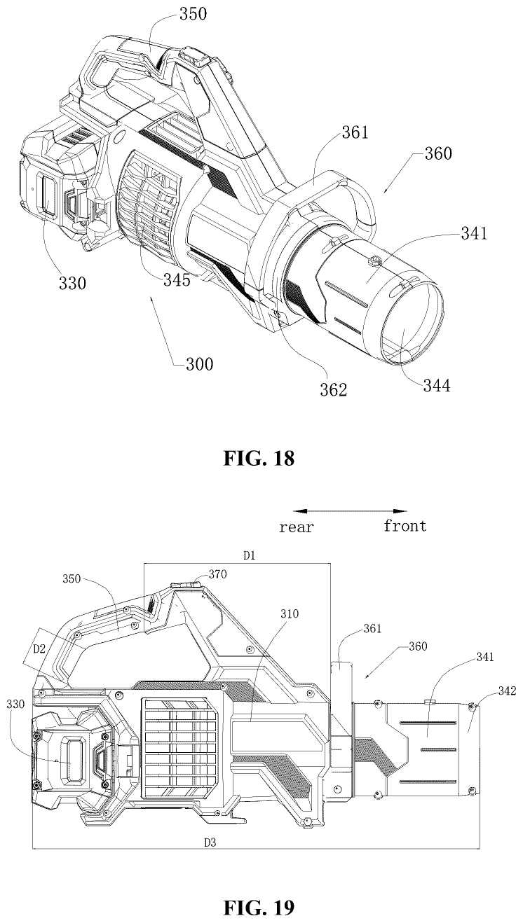

As shown in FIGS. 17 and 18, in some examples, the length of the battery pack 330 in an up and down direction is greater than the length of the battery pack 330 in the front and rear direction. The above arrangement facilitates an arrangement of the battery pack 330 on the blower 300 and can ensure the structural compactness of the blower 300.

As shown in FIG. 20, in some examples, the battery pack receptacle 331 is in contact with at most three sides of the battery pack 330. Through the above arrangement, the battery pack receptacle 331 designed to be open, while ensuring that the battery pack 330 can effectively mate with the battery pack receptacle 331 to achieve an electrical connection, can be matched with the battery packs 330 with different volumes according to actual usage occasions, thereby flexibly satisfying usage requirements on different occasions.

As shown in FIGS. 13 to 20, in some examples, the second handle 360 surrounds the blower tube assembly 340. The second handle 360 is mounted on the blower tube assembly 340 in a surrounding manner, ensuring a stable connection between the second handle 360 and the blower tube assembly 340. The second handle 360 includes a ring-shaped mounting portion 362 and a handle portion 361 integrated onto the ring-shaped mounting portion 362. The handle portion 361 is C-shaped, and an opening of the handle portion 361 is connected to the ring-shaped mounting portion 362. A hand accommodation space is formed between the handle portion 361 and the ring-shaped mounting portion 362, and the ring-shaped mounting portion 362 is sleeved on the blower tube assembly 340. The above arrangement facilitates the mounting of the second handle 360.

As shown in FIG. 15, in some examples, the first handle 350 extends along the direction of the central axis 320, and an extension direction of the second handle 360 is perpendicular to the direction of the central axis 320. The above arrangement enables two hands of the user to act on the first handle 350 and the second handle 360 at different angles during use, making it convenient to adjust the posture of the blower 300 according to environmental requirements.

As shown in FIGS. 13 to 15, in some examples, the second handle 360 includes a holdable portion lower than the central axis 320. The holdable portion lower than the central axis 320 is disposed on the second handle 360 so that the user can hold the blower sideways during use. Moreover, the second handle 360 is closer to the overall center of gravity and thus can be lifted alone when the blower 300 is not operating, saving efforts. After use, the blower 300 can be hung on the wall via the holdable portion lower than the central axis 320.

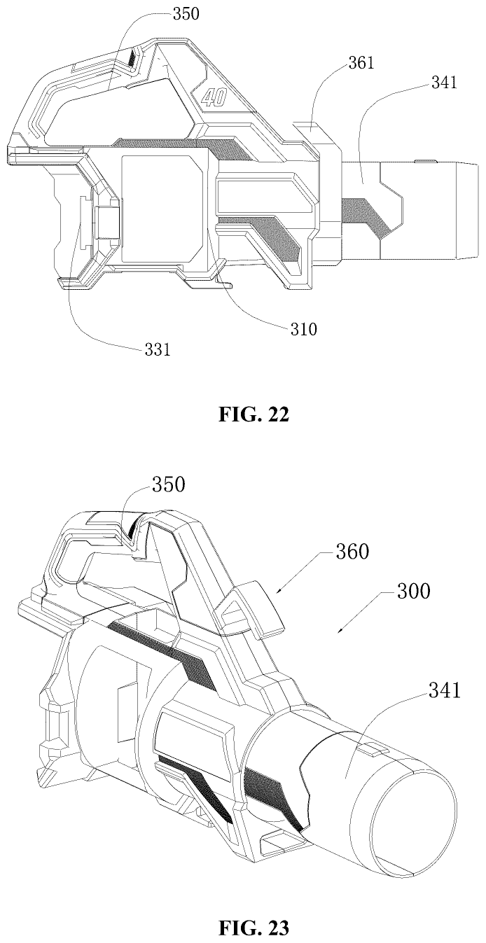

As shown in FIGS. 21 and 22, in some examples, the second handle 360 is tilted forward or rearward. During operation of the blower 300, a tilt direction of the second handle 360 is adjusted, making the blower 300 convenient for the user to use and better adapt to different usage occasions. The handle portion 361 of the second handle 360 may be rotatably disposed on the ring-shaped mounting portion 362. During use, an angle of rotation of the handle portion 361 relative to the ring-shaped mounting portion 362 may be directly adjusted as required.

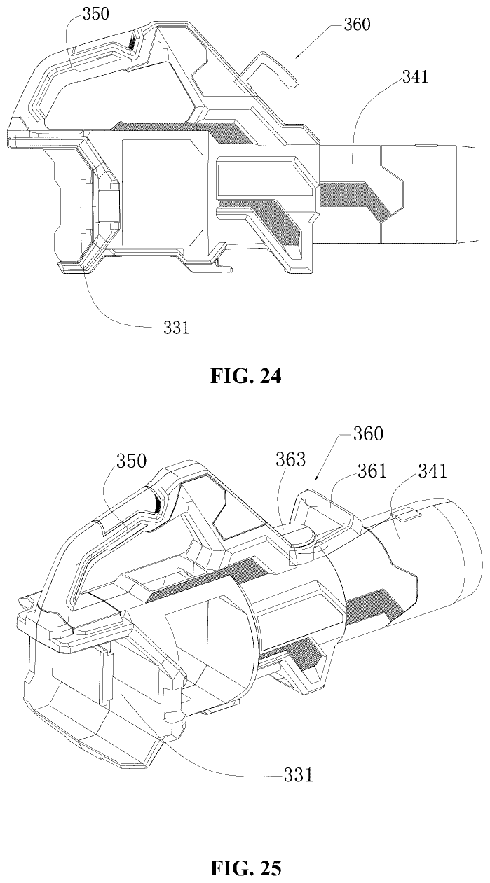

As shown in FIGS. 23 and 24, in some examples, the second handle 360 includes a first mounting position and a second mounting position. The second handle 360 is designed to be detachable so that the user can mount the second handle 360 to the first mounting position or the second mounting position according to actual requirements. The second handle 360 may be mounted with a bolt. The first mounting position is located on a side of the first handle 350 facing the air outlet 344. The second mounting position may be located on the left or right side of the first handle 350 or on the left or right side of a main tube 341. A threaded hole is provided at each of the first mounting position and the second mounting position. During use, the second handle 360 is placed at the first mounting position or the second mounting position, and the bolt penetrates through the second handle 360 and is connected to the threaded hole. In other examples, a snap-fit structure may be provided at each of the first mounting position and the second mounting position, and the second handle 360 may be mounted at the first mounting position or the second mounting position in a snap-fit manner, which is not much limited here. The second handle 360 may be designed to be L-shaped, which is easy to mount, simple in structure, and convenient for the user to hold.

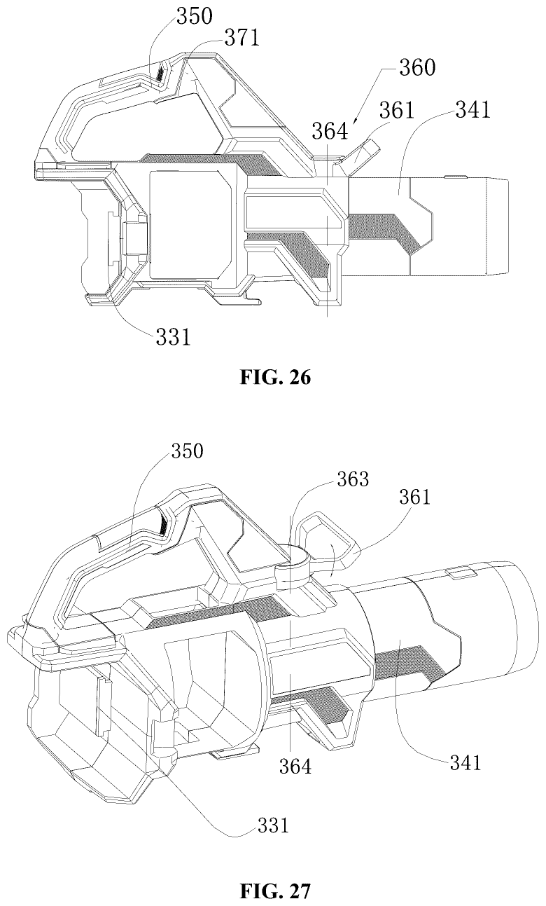

As shown in FIGS. 25 and 26, in some examples, the second handle 360 includes a first mounting position and a second mounting position, and the second handle 360 is rotatable from the first mounting position to the second mounting position. The second handle 360 includes a spindle portion 363 and a handle portion 361 that are connected to each other. A rotation axis 364 of the spindle portion 363 extends along the up and down direction, and the spindle portion 363 is rotatably disposed on a housing 310 of the blower 300. During use, the second handle 360 is adjusted to switch between the first mounting position and the second mounting position as required, satisfying the requirement for flexible use.

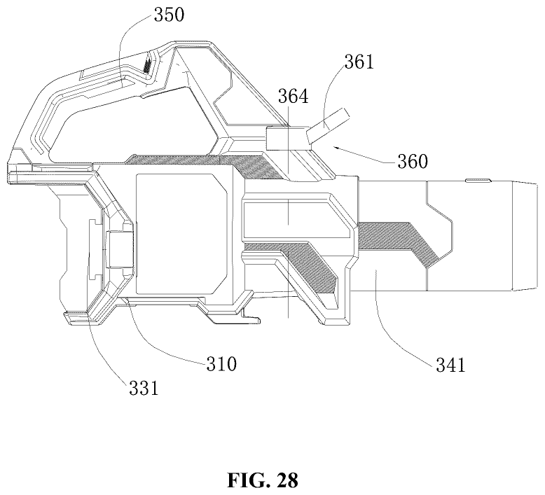

As shown in FIGS. 27 and 28, in some examples, the handle portion 361 and the spindle portion 363 may be designed to be rotatably connected to each other. During use, the second handle 360 is switched to the first mounting position or the second mounting position according to actual requirements, and then the handle portion 361 may be rotated relative to the spindle portion 363 to change an orientation of the handle portion 361, making the blower more convenient for the user to use.

As shown in FIG. 19, in some examples, the shortest distance D1 between a grip of the first handle 350 and a grip of the second handle 360 is greater than or equal to 200 mm. The shortest distance D1 between the grip of the first handle 350 and the grip of the second handle 360 refers to the distance from a position of the grip of the first handle 350 at which a trigger 371 is disposed to the grip of the second handle 360. For example, the shortest distance D1 between the grip of the first handle 350 and the grip of the second handle 360 may be 205 mm, 210 mm, 215 mm, 220 mm, 225 mm, 230 mm, 235 mm, 240 mm, 245 mm, etc. The shortest distance D1 between the grip of the first handle 350 and the grip of the second handle 360 is designed according to users in different regions to ensure the comfort of use, saving efforts while ensuring that the two hands of the user are not required to be spread too far apart.

As shown in FIG. 15, in some examples, the distance D5 between the overall center of gravity of the blower 300 and the position of the first handle 350 at which the trigger 371 is mounted is greater than or equal to 110 mm and less than or equal to 150 mm. For example, the distance D5 between the overall center of gravity of the blower 300 and the position of the first handle 350 at which the trigger 371 is mounted may be 112 mm, 114 mm, 116 mm, 118 mm, 120 mm, 122 mm, 124 mm, 126 mm, 128 mm, etc. The distance D5 between the overall center of gravity of the blower 300 and the position of the first handle 350 at which the trigger 371 is mounted is reasonably set, facilitating the use by the user and ensuring the effect of saving efforts.

As shown in FIGS. 13 to 22, the present application further provides a blower 300. The blower 300 includes a motor, a fan, a blower tube assembly 340, a battery pack receptacle 331, a first handle 350, and a second handle 360. The fan is driven by the motor to rotate about a central axis 320. The battery pack receptacle 331 is used for connecting a battery pack 330 to supply power to the motor. The blower tube assembly 340 is formed with an air inlet 345 for air intake and an air outlet 344 for air discharge, and the fan is accommodated in the blower tube assembly 340. The first handle 350 is used for a user to hold with one hand. The second handle 360 is disposed in front of the first handle 350 and used for the user to hold with the other hand. The second handle 360 includes a holdable portion lower than the central axis 320.

The first handle 350 and the second handle 360 are arranged in a front and rear direction so that the user can hold the first handle 350 and the second handle 360 with both hands along the front and rear direction, facilitating the handheld use. Moreover, handle addition enables the holding of the user with both hands and thus reduces the labor intensity during single-hand use. The second handle 360 includes the holdable portion lower than the central axis 320, making it convenient for the user to hold the blower sideways. After use, the blower can be hung on the wall via the holdable portion lower than the central axis 320, facilitating storage.

As shown in FIGS. 13 to 28, the present application further provides a blower 300. The blower 300 includes a motor, a fan, a battery pack receptacle 331, a blower tube assembly 340, and a first handle 350. The fan is driven by the motor to rotate about a central axis 320. The battery pack receptacle 331 is used for connecting a battery pack 330 to supply power to the motor. The blower tube assembly 340 is formed with an air inlet 345 for air intake and an air outlet 344 for air discharge. The first handle 350 extends along a direction of the central axis 320 and is located above the blower tube assembly 340. The battery pack receptacle 331 is disposed below the first handle 350 and behind the air inlet 345. The battery pack 330 is configured to be mounted to the battery pack receptacle 331 by sliding in a left and right direction. The battery pack receptacle 331 is in contact with at most three sides of the battery pack 330.

The battery pack 330 is designed to be detachable, making it convenient to quickly replace the battery pack 330 out of power. Moreover, since the battery pack receptacle 331 is in contact with at most three sides of the battery pack 330, the battery pack receptacle 331 is designed to be open so that battery packs 330 with different volumes can be replaced with each other according to actual requirements, flexibly satisfying requirements on different usage occasions. Additionally, the battery pack receptacle 331 is disposed below the first handle 350, and the battery pack 330 mounted subsequently can balance the overall center of gravity, thereby reducing a force on the wrist of a user during use and improving the user friendliness.

In some examples, the battery pack receptacle 331 is connectable to battery packs 330 with different capacities or different numbers of parallel cells. The battery pack receptacle 331 designed to be open can satisfy the requirement for mounting the battery packs 330 with different volumes, making it convenient for the user to configure corresponding battery packs 330 according to different occasions. For example, when the blower 300 is required to operate for a long time, a battery pack 330 with a relatively high capacity or a relatively large number of parallel cells is selected, which can satisfy the long-time power supply without frequently replacing the battery pack 330. When the blower 300 is required to operate for a short time, a battery pack 330 with a relatively low capacity or a relatively small number of parallel cells is selected so that the battery pack 330 is relatively light in weight and can reduce the labor intensity of the user using the blower 300.

As shown in FIG. 15, in some examples, the angle β at a connection between the first handle 350 and the battery pack receptacle 331 is greater than or equal to 50° and less than or equal to 80°. For example, the angle β at the connection between the first handle 350 and the battery pack receptacle 331 may be 51°, 52°, 53°, 54°, 55°, 56°, 57°, 58°, 59°, etc. The angle β at the connection between the first handle 350 and the battery pack receptacle 331 is reasonably designed so that a relatively large space is formed at the connection between the first handle 350 and the battery pack receptacle 331 to facilitate the holding of the user at the connection between the first handle 350 and the battery pack receptacle 331. Thus, the first handle 350 forms multiple grip positions.

As shown in FIGS. 13 to 28, the present application provides a blower 300. The blower 300 includes a motor, a fan, a battery pack receptacle 331, a blower tube assembly 340, and a first handle 350. The fan is driven by the motor to rotate about a central axis 320. The battery pack receptacle 331 is used for connecting a battery pack 330 to supply power to the motor. The blower tube assembly 340 is formed with an air inlet 345 for air intake and an air outlet 344 for air discharge, and the fan is accommodated in the blower tube assembly 340. The first handle 350 extends along a direction of the central axis 320 and defines a rearmost end of the blower 300. The first handle 350 includes multiple tubular portions connected in sequence, and a tubular portion at the rearmost end is holdable by a user.

Through the above arrangement, the first handle 350 and the central axis 320 extend in the same direction so that when the user holds the first handle 350 by hand, a force on the wrist is reduced, thereby reducing the labor intensity. Moreover, the first handle 350 has a certain length and thus is formed with multiple grip positions at different angles, and the tubular portion at the rearmost end can also be held by the user, making it convenient for the user to hold different positions as required and facilitating the use. The first handle 350 is designed to be tubular, and the tubular structure has good mechanical properties of bending and torsion resistance. Additionally, the first handle 350 is a hollow structure light in weight, thereby reducing the overall weight of the blower 300 and reducing the labor intensity of the user during handheld use.

As shown in FIGS. 13 to 20, in some examples, the first handle 350 is disposed above the battery pack 330, and the battery pack receptacle 331 is disposed behind the air inlet 345. Since the battery pack receptacle 331 is used for connecting the battery pack 330 and the battery pack 330 has a certain weight, the weight of the battery pack 330 can be utilized to balance a position of the overall center of gravity of the blower 300. The first handle 350 is designed to be above the battery pack 330 so that the force on the wrist of the user during handheld use can be reduced. The battery pack receptacle 331 is located behind the air inlet 345 so that when the battery pack 330 is mounted, the battery pack 330 does not interfere with other positions of the blower 300 in structure to facilitate the mounting of the battery pack 330, and battery packs 330 with different volumes can be configured according to actual requirements.

As shown in FIG. 19, in some examples, the length D2 of the tubular portion at the rearmost end is greater than or equal to 70 mm. For example, the length D2 of the tubular portion at the rearmost end may be 71 mm, 72 mm, 73 mm, 74 mm, 75 mm, 76 mm, 77 mm, 78 mm, 79 mm, 80 mm, etc. The length D2 of the tubular portion at the rearmost end is reasonably designed, ensuring the holding length of the user and making it convenient for the user to hold the tubular portion at the rearmost end to use the blower 300.

In some examples, the blower 300 can be held vertically by the user. When the blower 300 is held vertically by the user, the central axis 320 is substantially perpendicular to the ground. In this case, a hand of the user mainly holds the tubular portion of the first handle 350 at the rearmost end.

As shown in FIG. 17, in some examples, the blower 300 includes a trigger 371, and the trigger 371 is not disposed on the tubular portion at the rearmost end. During operation of the blower 300, the user is required to press the trigger 371 in real time so that a circuit between the battery pack 330 and the motor is conducted. After use, the hand of the user releases the trigger 371, the trigger 371 resets, and the motor stops rotating. Since the tubular portion at the rearmost end is mainly provided for the user to conveniently move the blower 300 when the blower 300 is not in use, the trigger not disposed on the tubular portion at the rearmost end can be prevented from being accidentally touched by the user.

As shown in FIGS. 13 to 28, in some examples, the blower 300 further includes a second handle 360. The second handle 360 is disposed in front of the first handle 350 and used for the user to hold with the other hand. The second handle 360 facilitates the holding of the user with both hands, ensuring the operation stability of the blower 300.

As shown in FIG. 17, on some application occasions when the user is required to use the blower 300 by holding the tubular portion at the rearmost end, since the trigger 371 is not disposed on the tubular portion at the rearmost end, the user fails to press the trigger 371 to control the blower 300 to operate. To solve the above problem, in some examples, the blower 300 further includes a retaining button 370 that maintains the continuous operation of the blower 300 even after the user releases the trigger. During use, the user operates the retaining button 370 so that the retaining button 370 is turned on, and the blower 300 can operate. In this case, the user can operate the blower 300 even when holding the tubular portion at the rearmost end. After use of the blower 300, the retaining button 370 is directly switched to an off state.

In different environments, the blower tube assembly 340 is sometimes required to have different lengths. To satisfy this requirement, in some examples, the blower tube assembly 340 is designed to be detachable. As shown in FIGS. 13 to 20, the blower tube assembly 340 includes a main tube 341 and an extension tube 343. The main tube 341 is integrated on a housing 310 of the blower 300. The diameter of the main tube 341 is greater than or equal to an outer diameter of a duct assembly of the blower 300 plus 8 mm, and the length of the main tube 341 is greater than or equal to the diameter of the air outlet 344 and less than or equal to 2.5 times the diameter of the air outlet 344. The front end of the main tube 341 has a flexible connection portion 342, and the extension tube 343 is detachably sleeved on the flexible connection portion 342. When a relatively long blower tube assembly 340 is required for operation, the extension tube 343 is sleeved on the main tube 341 to be used. The flexible connection portion 342 has a certain flexible bending ability so that the extension tube 343 can be deflected by a certain angle relative to the main tube 341 as required. When the extension tube 343 is not required for use, the extension tube 343 is directly removed.

As shown in FIG. 19, in some examples, the distance D3 from an end of the main tube 341 to the tubular portion at the rearmost end is greater than or equal to 532 mm. As shown in FIG. 15, after the extension tube 343 is mounted, the distance D4 from an end of the extension tube 343 to the tubular portion at the rearmost end is greater than or equal to 810 mm. For example, the distance D3 from the end of the main tube 341 to the tubular portion at the rearmost end may be 534 mm, 536 mm, 538 mm, 540 mm, 542 mm, 544 mm, 546 mm, 548 mm, 550 mm, etc. The distance D4 from the end of the extension tube 343 to the tubular portion at the rearmost end may be 812 mm, 814 mm, 816 mm, 818 mm, 820 mm, 822 mm, 824 mm, 826 mm, 828 mm, etc. The distance D3 from the end of the main tube 341 to the tubular portion at the rearmost end and the distance D4 from the end of the extension tube 343 to the tubular portion at the rearmost end are reasonably designed, making the blower convenient for the user to use on different occasions and easy to carry.

What is claimed is:

1. A blower, comprising:
a motor;
a fan driven by the motor to rotate about a central axis;
a battery pack receptacle for connecting a battery pack to supply power to the motor;
a blower tube assembly formed with an air inlet for air intake and an air outlet for air discharge, wherein the fan is accommodated in the blower tube assembly;
a first handle configured to be held by a user with one hand; and
a second handle disposed in front of the first handle and configured to be held by the user with the other hand;
wherein the first handle is disposed above the battery pack, and a top of the first handle is higher than a top of the second handle.

2. The blower according to claim 1, wherein the first handle is disposed above the blower tube assembly.

3. The blower according to claim 1, wherein the first handle extends along a direction of the central axis and comprises a plurality of tubular portions connected in sequence, and a rearmost tubular portion of the plurality of tubular portions is holdable.

4. The blower according to claim 1, wherein the battery pack receptacle is disposed behind the air inlet.

5. The blower according to claim 1, wherein the battery pack is mountable to the battery pack receptacle by sliding in a left and right direction.

6. The blower according to claim 1, wherein a length of the battery pack in an up and down direction is greater than a length of the battery pack in a front and rear direction.

7. The blower according to claim 1, wherein the second handle surrounds the blower tube assembly.

8. The blower according to claim 1, wherein the second handle comprises a holdable portion lower than the central axis.

9. The blower according to claim 1, wherein a shortest distance between a grip of the first handle and a grip of the second handle is greater than or equal to 200 mm.

10. The blower according to claim 1, wherein a distance between an overall center of gravity of the blower and a position of the first handle at which a trigger is mounted is greater than or equal to 110 mm and less than or equal to 150 mm.

11. A blower, comprising:
a motor;
a fan driven by the motor to rotate about a central axis;
a battery pack receptacle for connecting a battery pack to supply power to the motor;
a blower tube assembly formed with an air inlet for air intake and an air outlet for air discharge, wherein the fan is accommodated in the blower tube assembly;
a first handle extending along a direction of the central axis and defining a rearmost end of the blower;
wherein the first handle comprises a plurality of tubular portions connected in sequence, and a rearmost tubular portion of the plurality of tubular portions is holdable by a user.

12. The blower according to claim 11, wherein the first handle is disposed above the battery pack, and the battery pack receptacle is disposed behind the air inlet.

13. The blower according to claim 11, wherein an angle at a connection between the first handle and the battery pack receptacle is greater than or equal to 50 degrees and less than or equal to 80 degrees.

14. The blower according to claim 11, wherein a length of the rearmost tubular portion is greater than or equal to 70 mm.

15. The blower according to claim 11, wherein the blower is configured to be held vertically by the user.

16. The blower according to claim 11, wherein the blower further comprises a trigger, and the trigger is not disposed on the rearmost tubular portion.

17. The blower according to claim 11, further comprising a second handle disposed in front of the first handle for being held by the user's other hand.

18. A blower, comprising:
a motor;
a fan driven by the motor to rotate about a central axis;
a battery pack receptacle for connecting a battery pack to supply power to the motor;
a blower tube assembly formed with an air inlet for air intake and an air outlet for air discharge, wherein the fan is accommodated in the blower tube assembly;
a first handle configured to be held by a user with one hand; and
a second handle disposed in front of the first handle and configured to be held by the user with the other hand;
wherein the second handle comprises a holdable portion lower than the central axis.

19. The blower according to claim 18, wherein the second handle surrounds the blower tube assembly.

20. The blower according to claim 19, wherein the second handle has a spiral shape.
